(19) United States
(12) Patent Application Publication
(10) Pub. No.: US 2023/0342376 A1
(43) Pub. Date: Oct. 26, 2023

(54) SYSTEMS AND METHODS OF GENERATING AND USING ELECTRONIC RESOURCE MAPS

(71) Applicant: Daniel Conacher, Lausanne (CH)

(72) Inventor: Daniel Conacher, Lausanne (CH)

(21) Appl. No.: 18/137,477

(22) Filed: Apr. 21, 2023

Related U.S. Application Data
(60) Provisional application No. 63/333,142, filed on Apr. 21, 2022.

(51) Int. Cl. G06F 40/134; G06F 16/9535; G06F 16/955

(52) U.S. Cl. CPC G06F 40/134; G06F 16/9535; G06F 16/9558

(57) ABSTRACT

Systems and methods of generating and using electronic resource maps are disclosed. According to an aspect, a method includes determining a subject of interest. The method also includes receiving user input that identifies a plurality of electronic resources associated with the subject of interest. Further, the method includes receiving user input that identifies an association of the electronic resources to each other and the subject of interest. The method also includes creating an electronic resources map comprising a first data structure including first identifiers for the electronic resources and first links among the electronic resources based on the user input. Further, the method includes providing a subject of interest of a second data structure comprising second identifiers for a plurality of second electronic resources and second links among the second electronic resources. The method also includes linking at least one of the first electronic resources to other electronic resources.

### CROSS REFERENCE TO RELATED APPLICATION

This application claims priority to U.S. Provisional Patent Application No. 63/333,142, filed Apr. 21, 2022, and titled SYSTEMS AND METHODS OF GENERATING AND USING ELECTRONIC RESOURCE MAPS, the content of which is incorporated herein by reference in its entirety.

### TECHNICAL FIELD

The presently disclosed subject matter relates generally to information systems. Particularly, the presently disclosed subject matter relates to systems and methods of generating and using electronic resource maps.

### BACKGROUND

A “mind map” is generally considered to be a connected set of lists organized by similar categories. A mind map can be a diagram used to visually organize information. Further, a mind map can be hierarchical and show relationships among pieces of its data or information. A typical list is linear, but a mind map can be connected in all directions. A mind map can be used as a thinking tool for reflecting the information and/or actions within a person's head.

It is beneficial to provide mind maps that can be easily used and viewed with computer technology. In addition, it can be beneficial to improve the creation and utilization of mind maps for computer usage.

### BRIEF DESCRIPTION OF THE DRAWINGS

Having thus described the presently disclosed subject matter in general terms, reference will now be made to the accompanying Drawings, which are not necessarily drawn to scale, and wherein:

FIG. 1 illustrates a block diagram of a system for generating and using an electronic resources map;

FIG. 2 illustrates a flow diagram of a method of generating an electronic resources map in accordance with embodiments of the present disclosure;

FIG. 3 illustrates a screen display of an example electronic resources or mind map layout;

FIG. 4 a zoomed in view of a screen display that labels example basic constituents of an electronic resources map;

FIG. 5 is a screen display which shows an example of when a describer is clicked from the highlighted node;

FIG. 6 illustrates a flow diagram of a method of requesting an electronic resources map in accordance with embodiments of the present disclosure;

FIG. 7 illustrates a flow diagram of a method of a seeker searching for and finding an electronic resources map in accordance with embodiments of the present disclosure;

FIG. 8 illustrates a flow diagram of a method of how a seeker poses a subject or question of interest for vendors to find them in accordance with embodiments of the present disclosure;

FIG. 9 illustrates a screen display of the example electronic resources map show in FIG. 3 with a “right” layout;

FIG. 10 illustrates a flow diagram of a method of creating a unified electronic resources map in accordance with embodiments of the present disclosure;

FIG. 11 illustrates a screen display where a user can pose a specific question or become a vendor to share specific knowledge;

FIG. 12 illustrates a screen display of another example of a search bar that a user can utilize to find electronic resource maps;

FIG. 13 illustrates a screen display of an example of retrieved search results;

FIG. 14 illustrates a screen display of another example of retrieved search results;

FIG. 15 illustrates a screen display of yet another example of retrieved search results;

FIG. 16 is screen display of an example of an opened electronic resource map;

FIG. 17 is a screen display of another example of an opened electronic resource map;

FIG. 18 is a screen display of another example of a blank electronic resource map;

FIG. 19 is a screen display of another example of a unified electronic resource map;

FIG. 20 is a screen display of another example of a unified electronic resource map;

FIG. 21 is a zoomed-in screen display of an example of a section within FIG. 20;

FIG. 22 is a screen display of an example of a large, focused section within FIG. 20 as it expands from FIG. 21;

FIG. 23 is a screen display of another example of a focused section within FIG. 20;

FIG. 24 is a screen display of another example of a larger focused section within FIG. 20 as it expands from FIG. 22;

FIG. 25 is a screen display of another example of a unified electronic resource map;

FIG. 26 illustrates a screen display of an example of that unified electronic resource map being available to the public;

FIG. 27 illustrates a screen display with nodes having categorical ratings (top heart/no symbol) and scale ratings (bottom stars);

FIG. 28 illustrates a screen display with branches having categorical ratings (top heart/no symbol) and scale ratings (bottom stars); and

FIG. 29 is a screen display in which “Iliacus” is hyperlinked. In an example, when a user hovers your mouse over the word, the user can see the hyperlink in the bottom left corner.

### SUMMARY

The presently disclosed subject matter includes systems and methods of generating and using electronic resource maps. According to an aspect, a method includes determining a subject of interest. The method also includes receiving user input that identifies a plurality of electronic resources associated with the subject of interest. Further, the method includes receiving user input that identifies an association of the electronic resources to each other and the subject of interest. The method also includes creating an electronic resources map comprising a first data structure including first identifiers for the electronic resources and first links among the electronic resources based on the user input. Further, the method includes providing a subject of interest of a second data structure comprising second identifiers for a plurality of second electronic resources and second links among the second electronic resources. The method also includes determining that the subject of interest of the first data structure relates to the subject of interest of the second electronic resources.

According to another aspect, the subject of interest is associated with a query.

According to another aspect, the electronic resources are each identified by a web address and/or a hyperlink.

According to another aspect, a user interface is configured to present the first electronic resources map and the second electronic resources map to a user, and to receive user input for interaction with the first electronic resources map and the second electronic resources map.

According to another aspect, the method includes receiving user input for notating one or more of the electronic resources in the data structure.

According to another aspect, a method of using an electronic resources map includes providing an electronic resources map associated with a subject of interest, wherein the electronic resources map comprises a data structure including identifiers for electronic resources and links among the electronic resources based on the user input. The method also includes presenting, via a user interface, the electronic resources map to a user. Further, the method includes receiving, via the user interface, user input for interaction with the electronic resources map.

According to an aspect, the present subject matter also relates to e-commerce marketplaces specifically in the information, education, or knowledge industry.

### DETAILED DESCRIPTION

The following detailed description is made with reference to the figures. Exemplary embodiments are described to illustrate the disclosure, not to limit its scope, which is defined by the claims. Those of ordinary skill in the art will recognize a number of equivalent variations in the description that follows.

Articles “a” and “an” are used herein to refer to one or to more than one (i.e. at least one) of the grammatical object of the article. By way of example, “an element” means at least one element and can include more than one element.

“About” is used to provide flexibility to a numerical endpoint by providing that a given value may be “slightly above” or “slightly below” the endpoint without affecting the desired result.

The use herein of the terms “including,” “comprising,” or “having,” and variations thereof is meant to encompass the elements listed thereafter and equivalents thereof as well as additional elements. Embodiments recited as “including,” “comprising,” or “having” certain elements are also contemplated as “consisting essentially of” and “consisting” of those certain elements.

Unless otherwise defined, all technical terms used herein have the same meaning as commonly understood by one of ordinary skill in the art to which this disclosure belongs.

As used herein, the term “memory” is generally a storage device of a computing device. Examples include, but are not limited to, read-only memory (ROM) and random access memory (RAM).

As referred to herein, the terms “computing device” and “entities” should be broadly construed and should be understood to be interchangeable. They may include any type of computing device, for example, a server, a desktop computer, a laptop computer, a smart phone, a cell phone, a pager, a personal digital assistant (PDA, e.g., with GPRS NIC), a mobile computer with a smartphone client, or the like.

As referred to herein, a user interface is generally a system by which users interact with a computing device. A user interface can include an input for allowing users to manipulate a computing device, and can include an output for allowing the system to present information and/or data, indicate the effects of the user's manipulation, etc. An example of a user interface on a computing device (e.g., a mobile device) includes a graphical user interface (GUI) that allows users to interact with programs in more ways than typing. A GUI typically can offer display objects, and visual indicators, as opposed to text-based interfaces, typed command labels or text navigation to represent information and actions available to a user. For example, an interface can be a display window or display object, which is selectable by a user of a mobile device for interaction. A user interface can include an input for allowing users to manipulate a computing device, and can include an output for allowing the computing device to present information and/or data, indicate the effects of the user's manipulation, etc. An example of a user interface on a computing device includes a graphical user interface (GUI) that allows users to interact with programs or applications in more ways than typing. A GUI typically can offer display objects, and visual indicators, as opposed to text-based interfaces, typed command labels or text navigation to represent information and actions available to a user. For example, a user interface can be a display window or display object, which is selectable by a user of a computing device for interaction. The display object can be displayed on a display screen of a computing device and can be selected by and interacted with by a user using the user interface. In an example, the display of the computing device can be a touch screen, which can display the display icon. The user can depress the area of the display screen where the display icon is displayed for selecting the display icon. In another example, the user can use any other suitable user interface of a computing device, such as a keypad, to select the display icon or display object. For example, the user can use a track ball or arrow keys for moving a cursor to highlight and select the display object.

The display object can be displayed on a display screen of a mobile device and can be selected by and interacted with by a user using the interface. In an example, the display of the mobile device can be a touch screen, which can display the display icon. The user can depress the area of the display screen at which the display icon is displayed for selecting the display icon. In another example, the user can use any other suitable interface of a mobile device, such as a keypad, to select the display icon or display object. For example, the user can use a track ball or times program instructions thereon for causing a processor to carry out aspects of the present disclosure.

An interconnected web of ideas, or concepts, via a visual representation, can be commonly known as mind maps, topic maps, semantic networks, or concept maps, which are generally referred to herein as “electronic resource maps”. They are generally used as tools in areas such as project management, studying, workflow analysis, among other areas to organize ideas and structure information in a hierarchical or nonhierarchical formation. Their interconnected structure allows for the connection of ideas that do not have to be necessarily linear supporting creative and cognitive endeavors through seeing potential connections and how they potentially relate to the whole or the central concept or idea. The structure also allows for the user to go infinitely wide with the number of potential connected ideas, and/or infinitely deep on any one idea to greatly improve one's ability to understand. An electronic resource map as referred to herein, is a process where a vendor answers a specific question for the buyer using the structure of a mind-map where each ‘node’ in the mind-map is a resource (hyperlink to take the buyer to another location on the internet such as a blog, YouTube video, podcast, scientific paper, or a purchase page for a book, documentary, tool, etc.) or concept. The vendor also has the capacity to write about, or note, their opinion on each node via a describer, to allow for a deeper understanding of why it is included in the electronic resource map and how it relates to answering the buyer's question.

As referred to herein, a “seeker” or “buyer” refers to a person or an individual who is seeking information to better understand a concept or address their question of interest. A “vendor” is referred to a person or an individual who is making such content available, such as an electronic resource map.

In embodiments, the present disclosure provides methods that facilitate the consolidation of a variety of informational identifiers and potential descriptors, by a vendor, that pertain to the supporting of, and developing an answer to, questions of interest from the seeker, structured in a visual interconnected web (mind map) that the user can directly interact with (click on, navigate through, etc.). Hereinafter, it will be referred to as an electronic resource map. A “vendor” mayu to refer to a person who creates an electronic resource map.

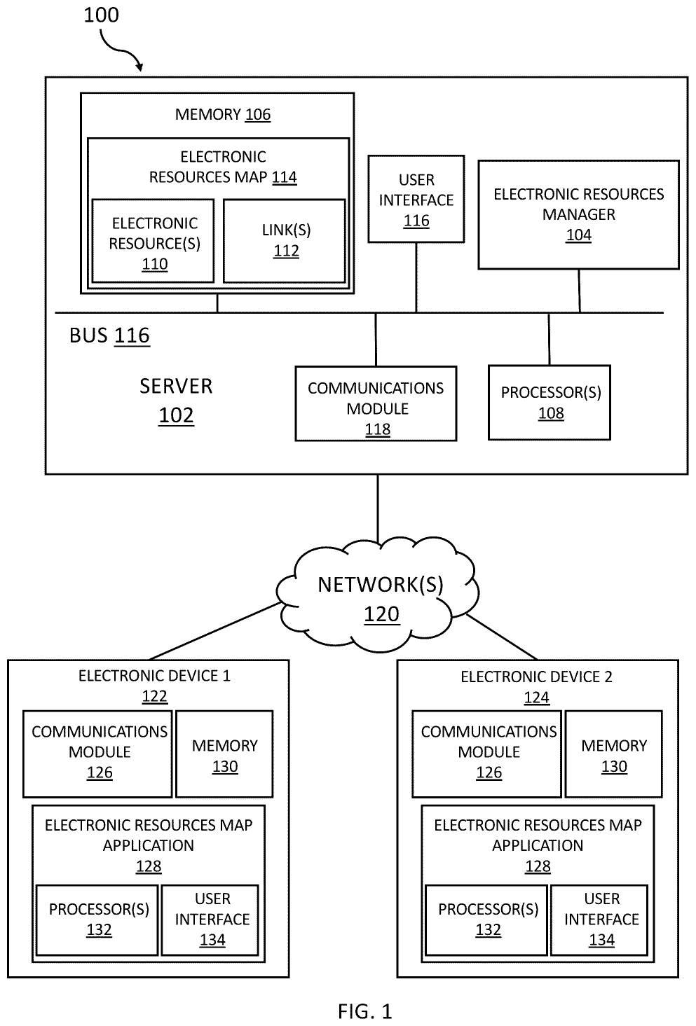

In accordance with embodiments, FIG. 1 illustrates a block diagram of a system 100 for generating and using an electronic resources map. Referring to FIG. 1, the system 100 includes a server 102 includes an electronic resources manager 104. The electronic resources manager 104 is configured to determine a subject of interest. The subject of interest may be a subject associated with one or more electronic resource maps. For example, the electronic resources manager 104 may create (or generate) and maintain an electronic resources map that links electronic resources associated with the subject. The electronic resources manager 104 can receive user input that identifies the electronic resources in the map that are associated with the subject of interest. Further, the electronic resources manager 104 can receive user input that identifies an association of the electronic resources to each other and the subject of interest. The electronic resources map can include a data structure including identifiers and links among the electronic resources based on the user input. For example, the electronic resources can be, but are not limited to, websites or other electronic resources. The electronic resources can be identified by a web address, a hyperlink, or the like. The electronic resources map can be accessed by other users for use in discovering the electronic resources linked by the map. In one example, the other users may enter a query used for searching, and the search results in finding the map based on the subject of the query.

The electronic resources manager 104 can also provide a subject of interest of one or more other data structures. Each of the other data structures can include identifiers of electronic resources and links among the electronic resources. Subsequently, the electronic resources manager 104 can determine that the subject of interest of the other data structure(s) relates to the subject of interest of any of the data structures. In response to determining that the subjects of interest are related, the electronic resources can be linked. In this way, a user discovering one of the data structures can search to find the related data structure(s) by the link of the subject matter.

With continuing reference to FIG. 1, the functionalities of the electronic resources manager 104 described herein can be implemented by hardware, software, firmware, or combinations thereof. For example, the server 102 may include memory 106 and one or more processor(s) 108 for implementing the functionalities of the electronic resources manager 104. The memory 106 may store electronic resources 110 and links 112 for forming an electronic resources map 114 as described herein. Although only one (1) electronic resources map 114 may is shown in FIG. 1, it should be appreciated that the server 102 may store more than one electronic resources map 114.

The server 102 may also include a user interface 116 for a user of the server to input commands or to receive presentation of information and/or graphics. For example, the user interface 116 may include a keyboard, a mouse, a display, a printer, or the like. The server 102 may also include a bus 116 for providing communication between components of the server, such as the memory 106 and the processor(s) 108. Further, the server 102 may include a communication module 118 configured to communicate with one or more networks 120 for further communicating with other electronic devices, such as electronic devices 122 and 124.

Electronic devices 122 and 124 may be utilized by different users and are further differentiated in FIG. 1 with the labels “ELECTRONIC DEVICE 1” and “ELECTRONIC DEVICE 2”. Each electronic device 122 and 124 includes a communications module 126 to thereby communicate with the server 102 via the network(s) 120. It is noted that other electronic devices may have the same functionalities as electronic devices 122 an 124 and be communicatively connected to the server 102.

Each electronic device 122 and 124 includes an electronic resources map application 128 for use to create and utilize an electronic resources map, such that the electronic resources map 114 residing at server 102. The application 128 may be implemented by hardware, software, firmware, or combinations thereof residing in the electronic device. For example, the application 128 may be implemented by the memory 130 and one or more processors 132 of the respective electronic device 122 or 124. Further, the electronic devices 122 and 124 may each include a user interface 134 for receiving user input and for presenting information and graphics related to the creation and use of an electronic resources map as described herein. For example, the user interface 134 may be include, but is not limited to, a display (e.g., a touchscreen display), a keyboard, a mouse, and/or the like.

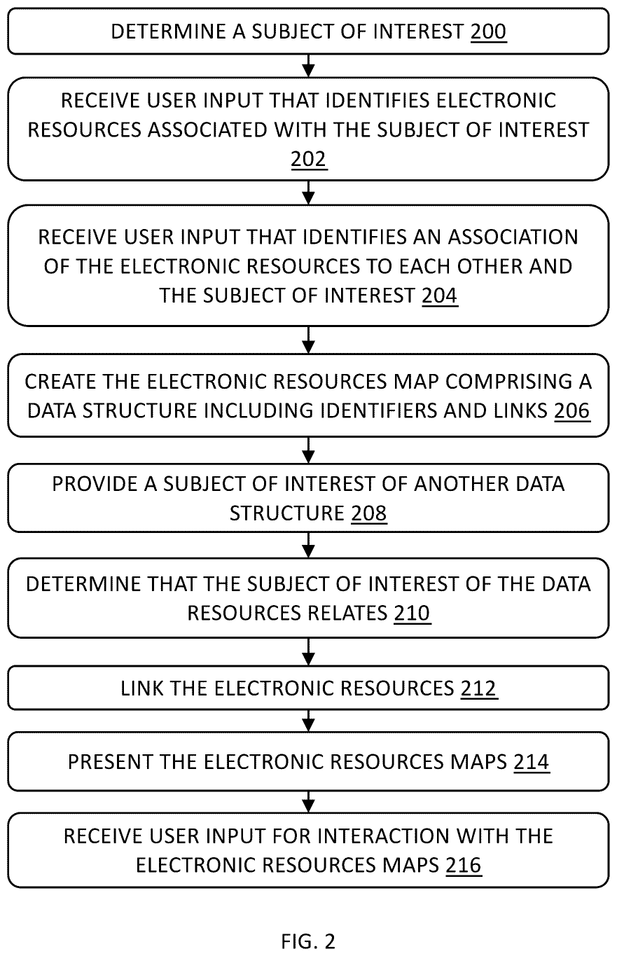

FIG. 2 illustrates a flow diagram of a method of generating an electronic resources map in accordance with embodiments of the present disclosure. It is noted that the method of FIG. 2 is described by example with reference to the system 100 of FIG. 1; however, it should be understood that the method may alternatively be implemented by any other suitable system having one or more electronic devices. For example, the method may be implemented by one electronic device or multiple electronic devices having the functionalities of the method.

Referring to FIG. 2, the method includes determining 200 a subject of interest. In the example of FIG. 1, the electronic resources manager 104 at the server 102 may determine a subject of interest. For example, a user of electronic device 1 122 can initiate creation of an electronic resources map at the server 102, and subsequently enter a subject of interest for the electronic resources map. The application 128 of the electronic device 122 can be used for entry of the subject via the user interface 134. The communications module 126 of the electronic device 122 can send an indicator of the subject to the server 102. The communication module 118 can receive the indicator of the subject and can relay the indicator of the subject to the electronic resources manager 104. As a result, the electronic resources manager 104 can determine the subject of interest by this example; however, it should be appreciated that the subject of interest may alternatively be determined by the electronic resources manager 104.

The method of FIG. 2 includes receiving 202 user input that identifies electronic resources associated with the subject of interest. Continuing the aforementioned example, the user of electronic device 122 can utilize the user interface 134 to identify electronic resources for association with the subject of interest for the electronic resources map. For example, the user may enter web addresses, hyperlinks, or the like. A web address, for example, can be the address for a website or webpage with content the user intends to be associated with the electronic resources map. A hyperlink, for example, can point to content the user intends to be associated with the electronic resources map. Identification of the electronic resources may be communicated by the communications module 126 to the server 102 via the network(s) 120.

The method of FIG. 2 includes receiving 204 user input that identifies an association of the electronic resources to each other and the subject of interest. Continuing the aforementioned example, the user of the electronic device 122 can enter information or data for associating the identified electronic in relation to each other. For example, one resource may provide background information of the subject and others of the electronic resources may provide more detailed information about the subject. The background electronic resource may be linked to the other electronic resources providing details. In an example, the electronic resources may be organized by link in a hierarchy. In this example, the electronic resources higher in the hierarchy may provide broader or general information, and the others may provide the details. Identification of the association of electronic resources may be communicated by the communications module 126 to the server 102 via the network(s) 120.

The method of FIG. 2 includes creating 206 the electronic resources map comprising a data structure including identifiers for the electronic resources and links among the electronic resources based on the user input. Continuing the aforementioned example, the electronic resources manager 104 can create the electronic resources map comprising a data structure including identifiers for the electronic resources and links among the electronic resources based on the user input. For example, the created electronic resources map can be map 114 stored in memory 106. This map is created based on the user input of identified electronic resources and association of the electronic resources.

The method of FIG. 2 includes providing 208 a subject of interest of another data structure comprising other identifiers for other electronic resources and links and the other electronic resources. Continuing the aforementioned example, the user of electronic device 2 124 can enter a subject of interest, which may be the same or similar to the subject of interest determined at step 200. The entered subject of interest may be communicated, by the communications module 126, to the server 102 via the network(s) 120. Alternatively, this subject of interest may be entered by the user at electronic device 122 or another electronic device, and subsequently the entered subject of interest may be communicated to the server 102.

The method of FIG. 2 includes determining 210 that the subject of interest of the initial data resources (entered at step 202) relates to the subject of interest of the other electronic resources (entered at step 208). Continuing the aforementioned example, the electronic resources manager 104 can compare the subjects of interest to determine whether they are the same or similar. To determine similarity, the electronic resources manager 104 can compare key-terms within the subjects of interest to judge the likeness. Another example approach to determine similarity between subjects of interest is if one informational resource can address the subjects of interest being compared.

The method of FIG. 2 includes linking 212 at least one of the initial electronic resources (entered at step 202) to at least one of the other electronic resources (entered at step 208) based on the determination that the subject of interest of the initial data structure relates to the subject of interest of the second electronic resources. Continuing the aforementioned example, the electronic resources manager 104 can link the electronic resources entered by the user of electronic device 122 to the electronic resources entered by the user of electronic device 124. The linking can be based on the determination that the 2 identified subjects of interest are related. One example of linking the electronic resources is copying the nodes from one electronic resource to the other. Another example of linking the electronic resources is to copy all of the nodes into a new electronic resources combining all the contents of the initial data structures.

The method of FIG. 2 includes presenting 214 the electronic resources maps to a user. Continuing the aforementioned example, the electronic resources manager 104 can present the electronic maps to a user. For example, an electronic device, such as electronic device 124 may be used to select the electronic resources stored at server 102 for presentation. Continuing the aforementioned example, the electronic resource manager 104 can send the user a link to the electronic resource map where the user can click to have access to the contents within the electronic resource map.

The method of FIG. 2 includes receiving 216 user input for interaction with the electronic resources maps. Continuing the aforementioned example, the user can interact with the electronic resource map by scrolling left and right and up and down, zooming in and out, clicking on identifiers and describers within the nodes.

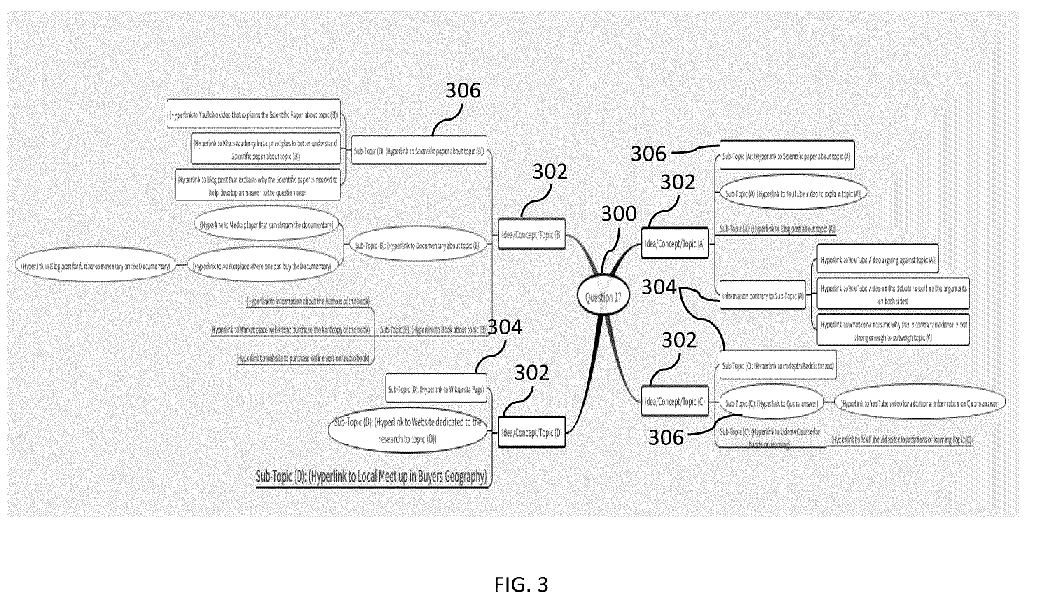

FIG. 3 illustrates a screen display of an example electronic resources or mind map layout. Referring to FIG. 3, this is an example that is created in the form of a template to illustrate an example structure and example types of information resources that can be included. It should be understood that the types listed is not exhaustive list. In this example, the central subject of interest (or question of interest) (herein, the “the central subject or question of interest” will be referred to as “the subject of interest”) is identified by reference numeral 300 posted in the center of the electronic resources map inside the largest node. Stemming from the central node 300 can be questions, ideas, concepts, or topics (herein after, “questions, ideas, concepts, or topics” will be shortened to “identifiers” to represent these possibilities), which are indicated by reference numerals 302. Branching from each identifier 302, can be sub-identifiers or child identifiers 304, that relate to the main identifier or parent identifier 302, and can include a clickable hyperlink 306 to an external website to allow the user to go more in-depth on that sub-identifier 304. Sub-identifiers 304 can have sub-sub identifiers and so on. There can be any suitable number of identifiers and sub-identifiers. This is how the user can go infinitely wide with any number of potential identifiers and infinitely deep on any one identifier via sub-identifiers.

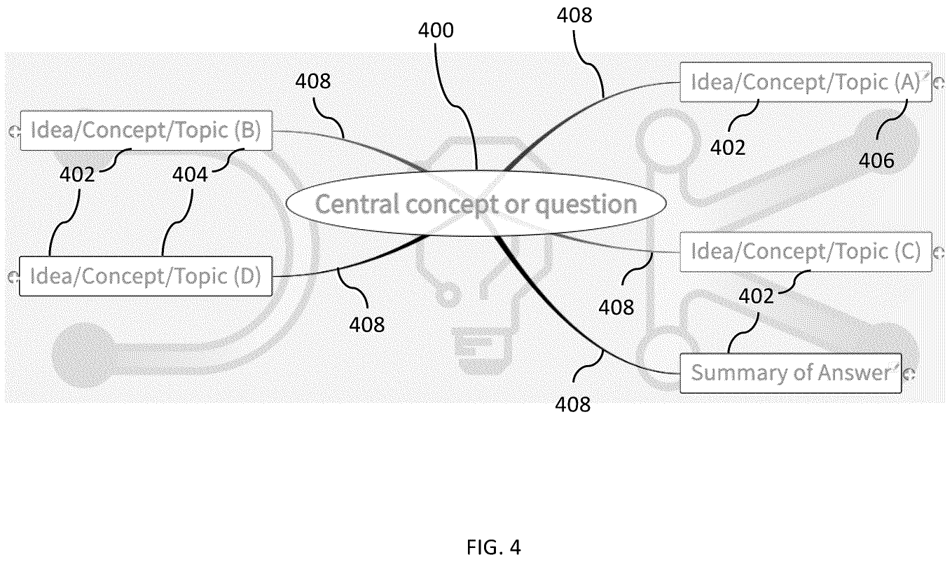

FIG. 4 a zoomed in view of a screen display that labels (in brackets and using arrows to denote each constituent) example basic constituents of an electronic resources map. The basic constituents of the electronic resources map in this example are a central node 400, nodes 402, identifiers 404, describers 406, and branches 408. The central node 400 is the subject or question of interest that the rest of the nodes 402 and describers 406 in the mind map can address. The nodes 402 each carry every other identifier 404 the user can add to address the central node 400. The describer 406, where in this example is denoted by the pencil icon, is an area the user can add or notate their own thoughts on each individual identifier should they choose to. The branch 408 is the connection between nodes to show they are related or connected.

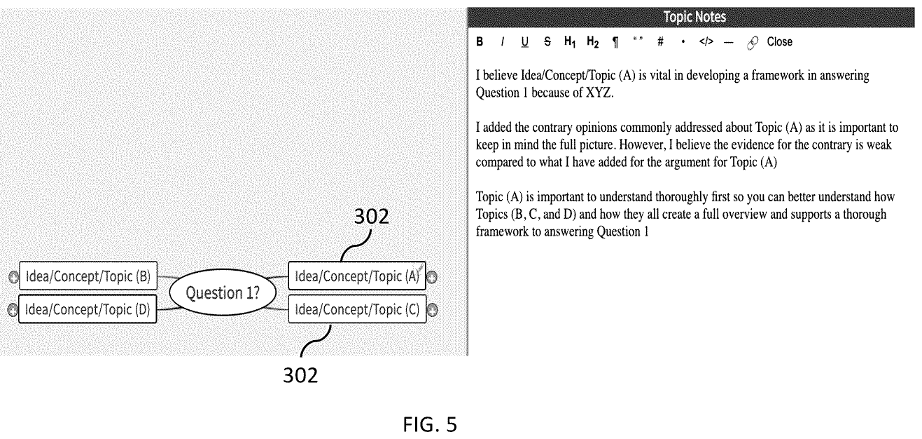

FIG. 5 is a screen display which shows an example of when a describer is clicked from the highlighted node, i.e., “Idea/Concept/Topic (A). Within the describer is an example template of how a user can add their notations or thoughts on the identifier within that one specific node. The capacity to add a describer is available for all nodes

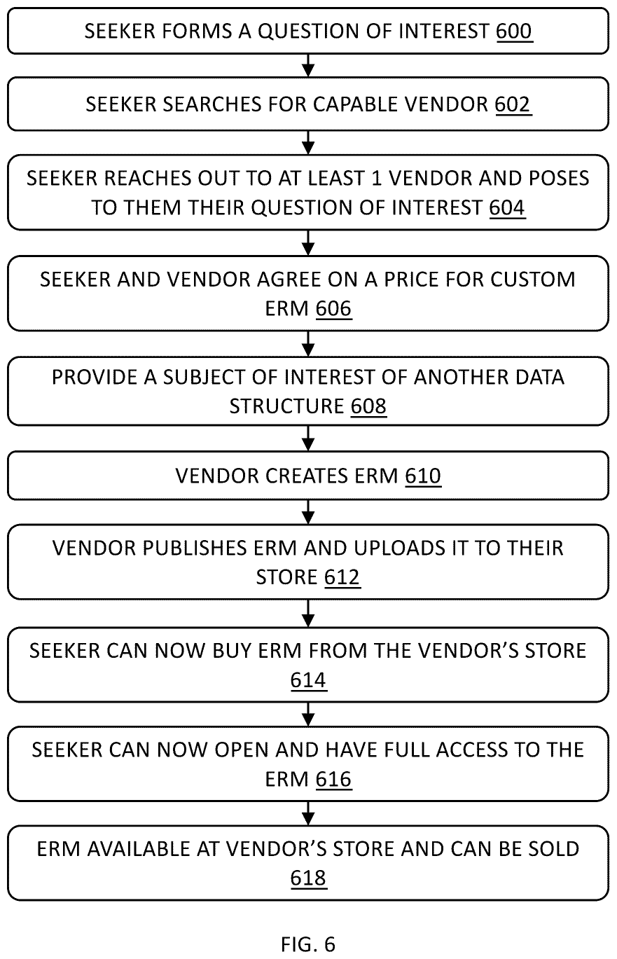

FIG. 6 illustrates a flow diagram of a method of requesting an electronic resources map in accordance with embodiments of the present disclosure. It is noted that the method of FIG. 5 is described by example with reference to the system 100 of FIG. 1; however, it should be understood that the method may alternatively be implemented by any other suitable system having one or more electronic devices. For example, the method may be implemented by one electronic device or multiple electronic devices having the functionalities of the method. In one example, the method can be implemented a seeker cannot find an adequate electronic resources map that has already been created to address a specific subject of interest or a specific question of interest. In this case, the method may be used for a seeker to reach out to appropriate vendors to make one.

The method of FIG. 6 can be implemented at the server 102 and the electronic device 122 in this example. Initially, a user at electronic device 122 can use the application 128 to request a custom electronic resources map. Once the seeker has formed her or his question at step 600, the seeker can search (step 602) using key terms. The seeker can read through the vendor profiles and ratings to find a vendor they feel would be the right person to create a DoK for their specific question. Once the seeker finds one or multiple vendors, the seeker reaches out to one or more of them via direct message and poses their question (step 604). For example, one of them vendors may utilize electronic device 124. Through this medium of communication, the seeker and vendor can discuss any details, including a potential price, that they feel is needed (step 606). Once both parties agree on the details, the vendor can create the electronic resources map (step 608). Once created, the electronic resources map can be uploaded or published onto the vendors store (step 610), such as in the memory 106 of the server 102. The vendor can notify the seeker and the seeker can now purchase (step 612), open, and interact with the electronic resources map (step 614). This electronic resources map is also now available to the public and can be sold an unlimited number of times (step 616).

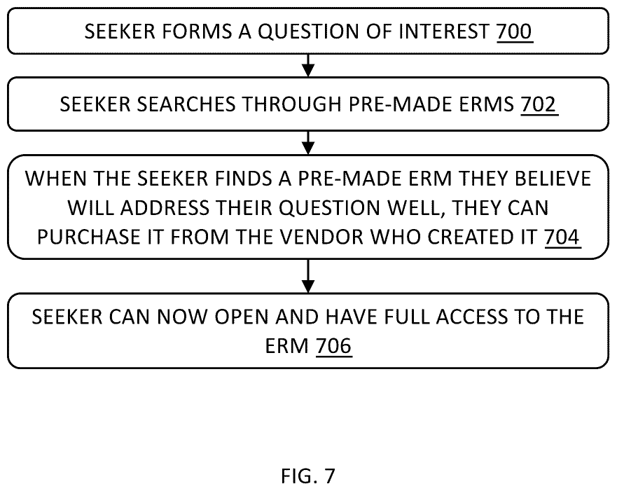

FIG. 7 illustrates a flow diagram of a method of a seeker searching for and finding an electronic resources map in accordance with embodiments of the present disclosure. It is noted that the method of FIG. 7 is described by example with reference to the system 100 of FIG. 1; however, it should be understood that the method may alternatively be implemented by any other suitable system having one or more electronic devices. FIG. 7 is the sequence of how the seeker finds a premade electronic resources map. Once the seeker as formed their question of interest (step 700), they can search through electronic resources map that have already been created via the products page or using key terms in the search bar (step 702). The seeker can evaluate the electronic resources maps description, previous ratings, and the vendor who created via the vendor's profile. The seeker can also reach out to the vendor to ask any further questions. Once the seeker has found an electronic resources map they think will address their question well, they can purchase it (step 704). Once it is purchased, the seeker will have immediate access to open, view, and interact with the electronic resources map and all its content (step 706).

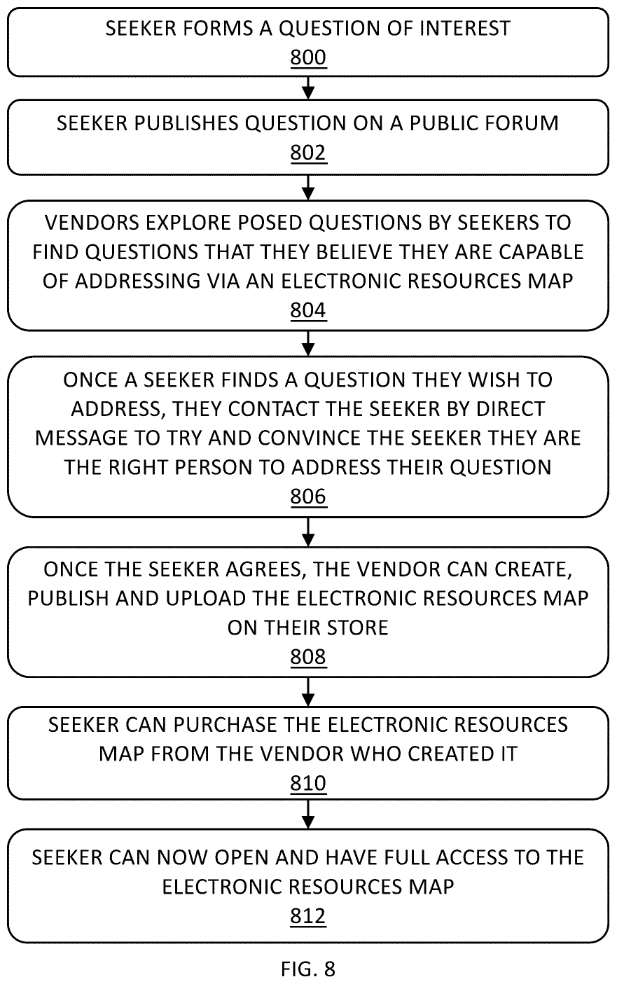

FIG. 8 illustrates a flow diagram of a method of how a seeker poses a subject or question of interest for vendors to find them in accordance with embodiments of the present disclosure. It is noted that the method of FIG. 8 is described by example with reference to the system 100 of FIG. 1; however, it should be understood that the method may alternatively be implemented by any other suitable system having one or more electronic devices. Referring to FIG. 8, if a seeker prefers to have vendors approach them, the seeker can form a question of interest (step 800) and publish the open question on a public forum (step 802). Vendors can go through the questions available and reach out to the seekers via direct message (step 804) if they believe they are the right person to create the electronic resources map to address the seekers question (step 806). Once the seeker agrees, the vendor can create the electronic resources map to address the posed question by the seeker (step 808). Once completed, the vendor can publish the electronic resources map on their store and the seeker can purchase (step 810), open, and interact with the contents of the electronic resources map (step 812).

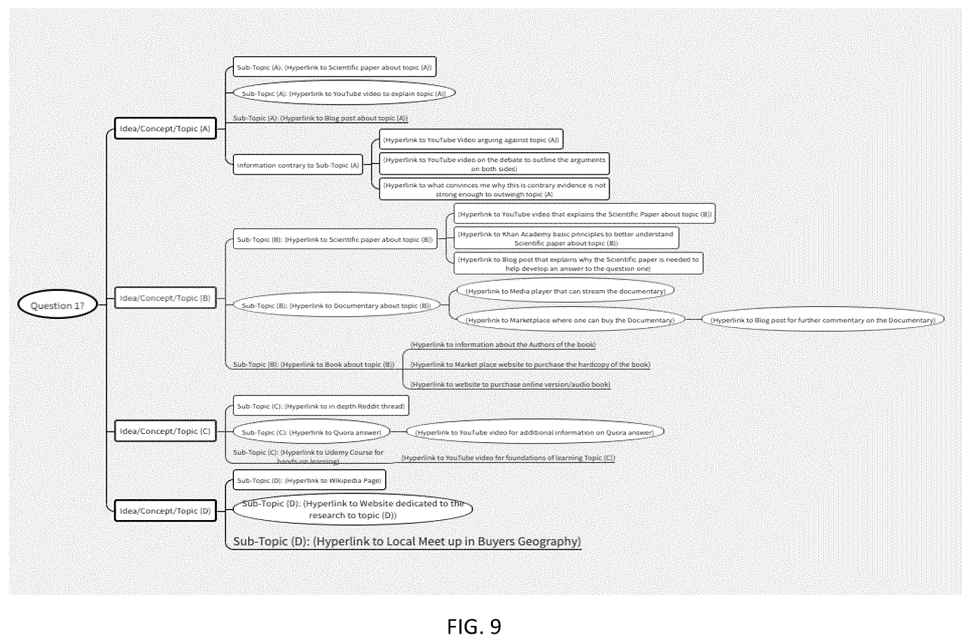

FIG. 9 illustrates a screen display of the example electronic resources map show in FIG. 3 with a “right” layout. The structure of the electronic resources map can be structured in multiple ways depending on what the vendor thinks is the best way to lay out the information.

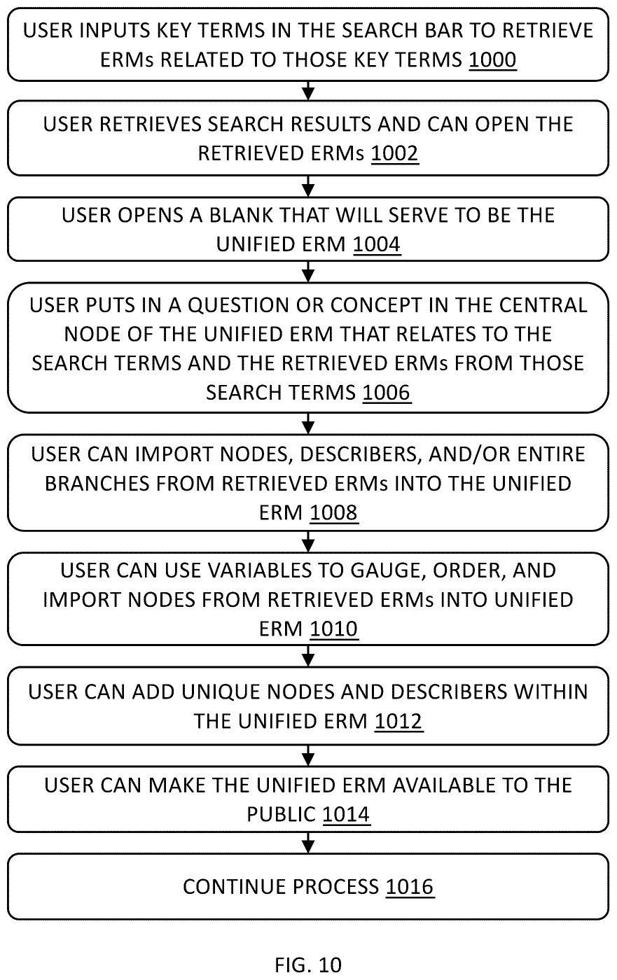

FIG. 10 illustrates a flow diagram of a method of creating a unified electronic resources map in accordance with embodiments of the present disclosure. It is noted that the method of FIG. 10 is described by example with reference to the system 100 of FIG. 1; however, it should be understood that the method may alternatively be implemented by any other suitable system having one or more electronic devices.

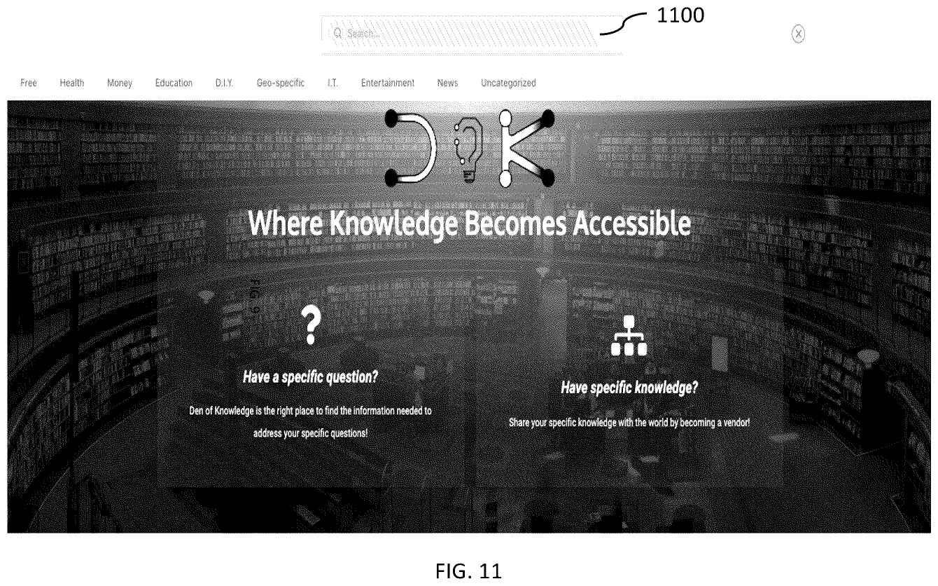

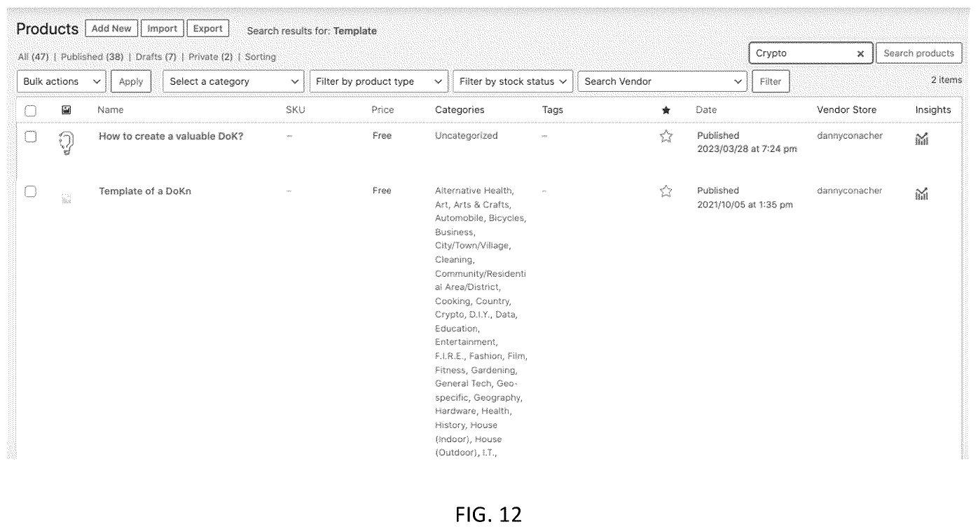

Referring to FIG. 10, the method includes a user inputting 1000 key terms in a search bar to retrieve electronic resource maps related to those key terms. For example, FIG. 11 illustrates a screen display where a user can pose a specific question or become a vendor to share specific knowledge. Referring to FIG. 11, the user can enter key terms in the search bar 1100. Further, for example, FIG. 12 illustrates a screen display of another example of a search bar that a user can utilize to find electronic resource maps. A user can be a person, persons, or a computer program or some combination thereof. In an example, the user can be the operator of electronic device 122 shown in FIG. 1.

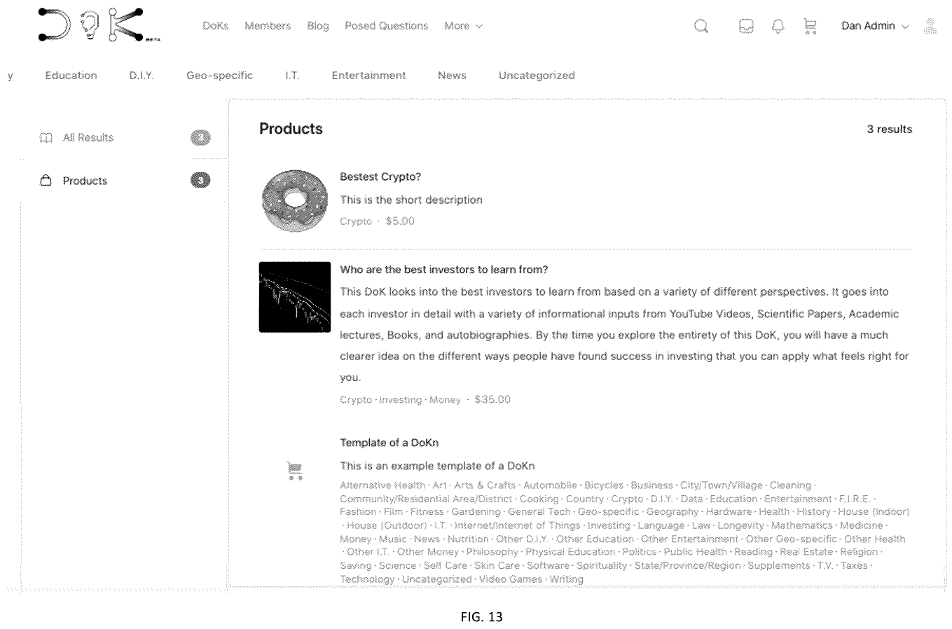

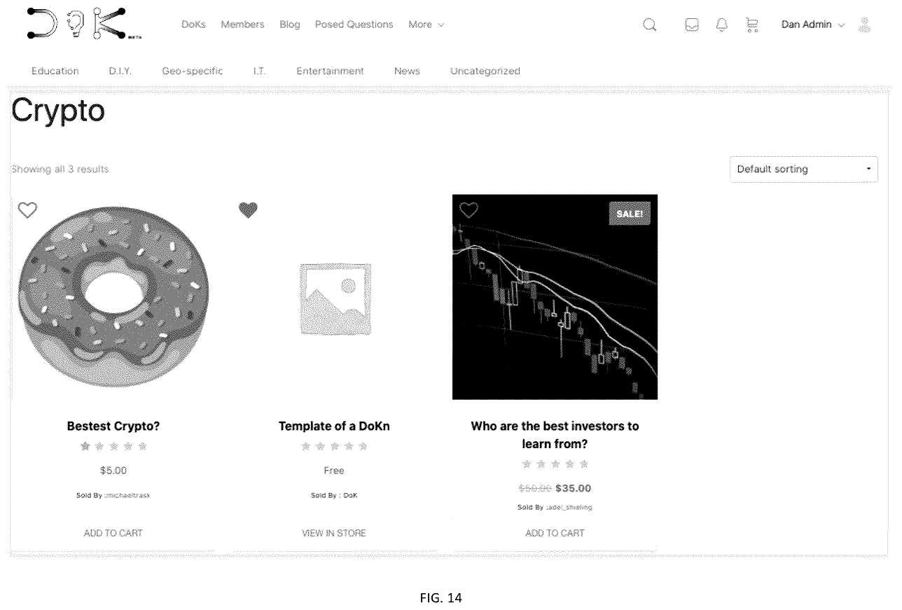

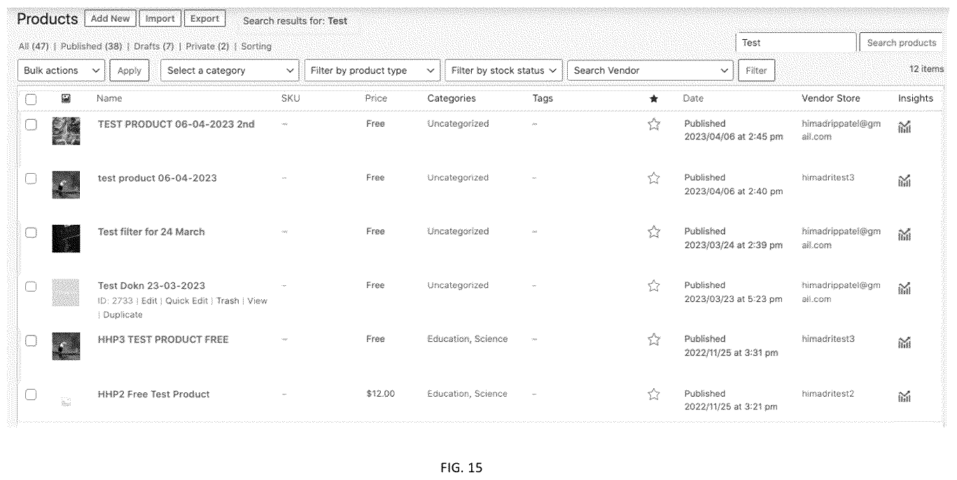

A user can start with collecting related electronic resource maps using key words in the search tool. Returning to FIG. 10, the search tool can retrieve electronic resource maps related to the search terms. This step can be implemented by the electronic resources manager 104 at the server 102 shown in FIG. 1. The user can open and interact with the retrieved electronic resource maps from the search (step 1002). For example, FIG. 13 illustrates a screen display of an example of retrieved search results. This screen display can assist the user with viewing the retrieved search results. The search term is “crypto” in the example of FIG. 13. Further for example, FIG. 14 illustrates a screen display of another example of retrieved search results. The search term is also “crypto” in the example of FIG. 14. Further for example, FIG. 15 illustrates a screen display of yet another example of retrieved search results. In the example of FIG. 15, the search term is “Test”.

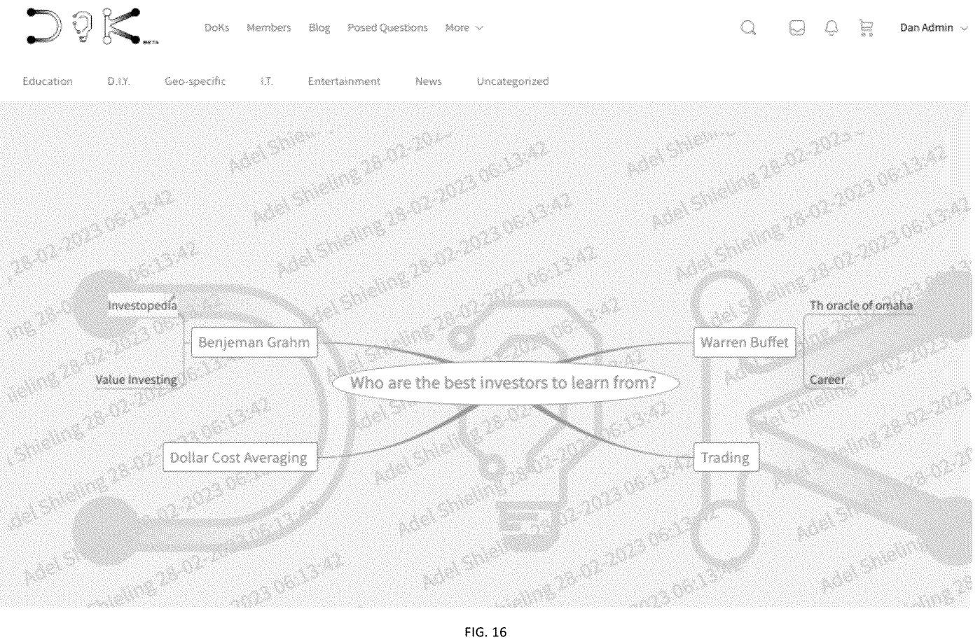

Referring again to FIG. 10, the method includes opening 1004 a blank electronic resource map that can serve to be the unified electronic resource map. For example, the user at the electronic device 122 shown in FIG. 1 can open up a new blank electronic resource map that can be the place for the unified electronic resource map. Here, the user can write text in the central node to embody the retrieved related electronic resource maps. FIG. 16 is screen display of an example of an opened electronic resource map. When a DoK is opened, a user can scroll around, zoom in and out, click on hyperlinks, and open describers. The user may utilize the electronic device 122 to enter a question or concept in the central node of the unified electronic resource map that relates to the search terms and the retrieved electronic resource maps from those search terms (step 1006).

With continuing reference to FIG. 10, the user can start to import branches, nodes and their identifiers, and describers from the retrieved electronic resource maps into the unified electronic resource map (step 1008).

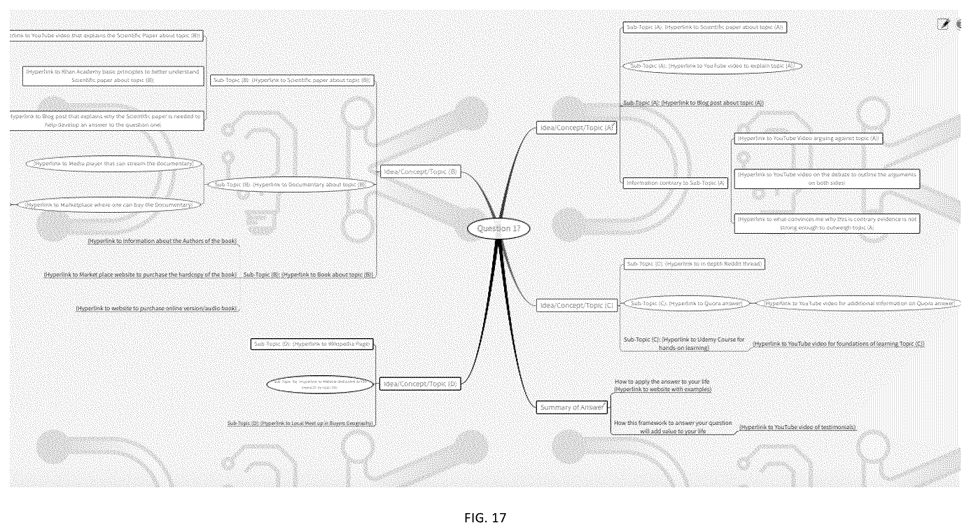

FIG. 17 is a screen display of another example of an opened electronic resource map.

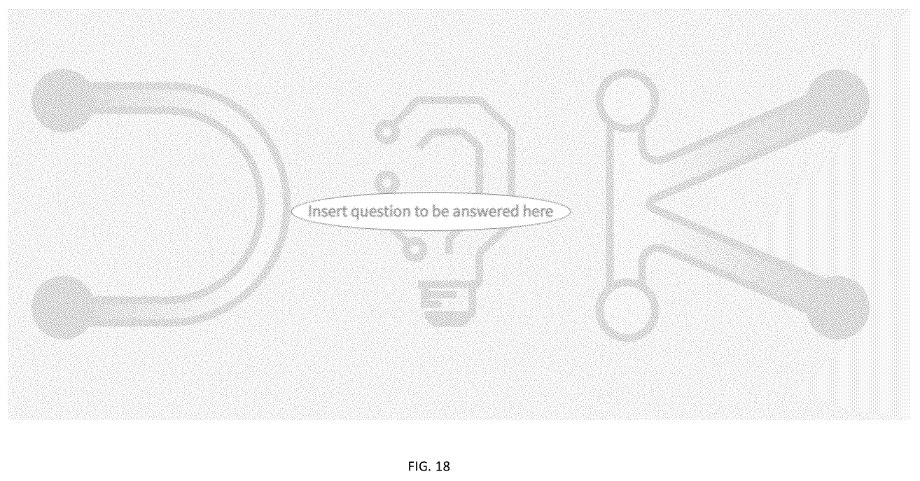

FIG. 18 is a screen display of another example of a blank electronic resource map.

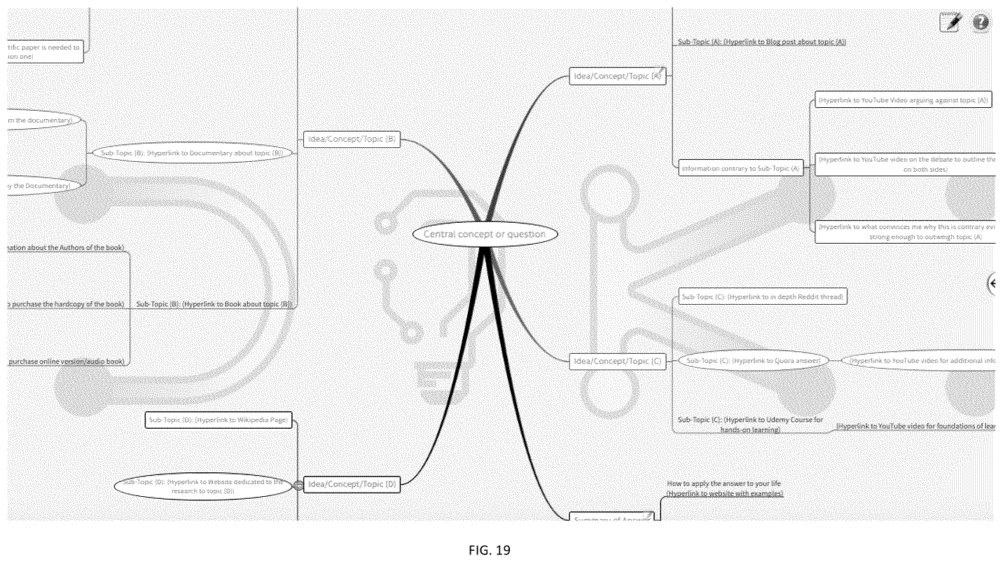

FIG. 19 is a screen display of another example of a unified electronic resource map. A unified electronic resource map can be an electronic resource mapthat combines at least 2 or more related DoKs into one DoK.

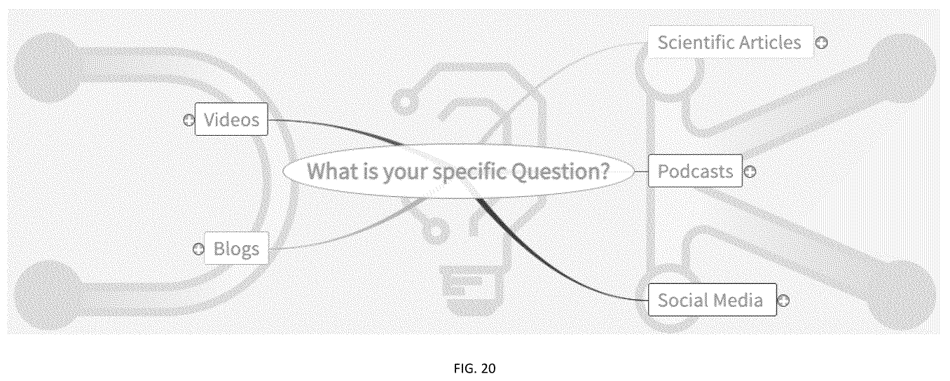

FIG. 20 is a screen display of another example of a unified electronic resource map.

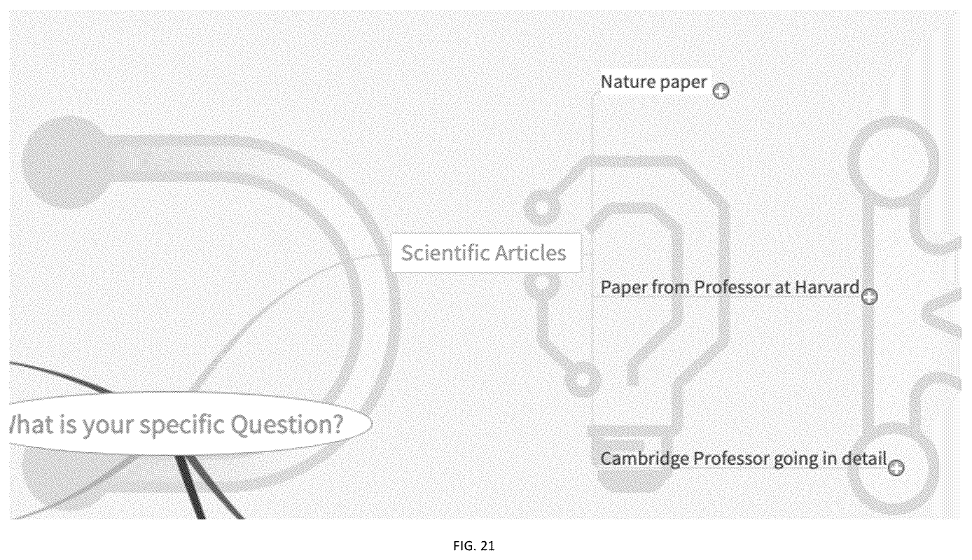

FIG. 21 is a zoomed-in screen display of an example of a section within FIG. 20.

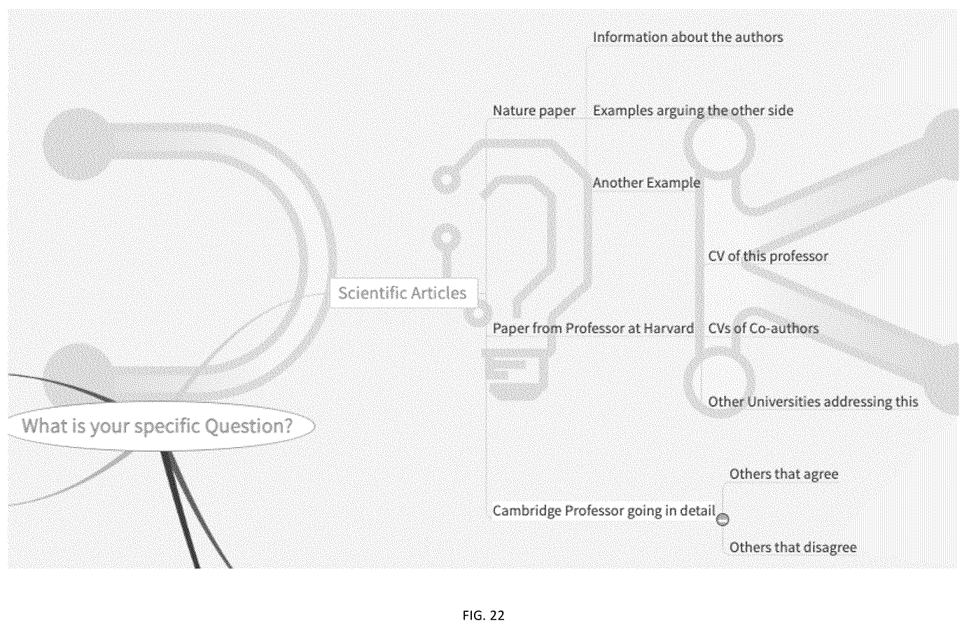

FIG. 22 is a screen display of an example of a large, focused section within FIG. 20 as it expands from FIG. 21.

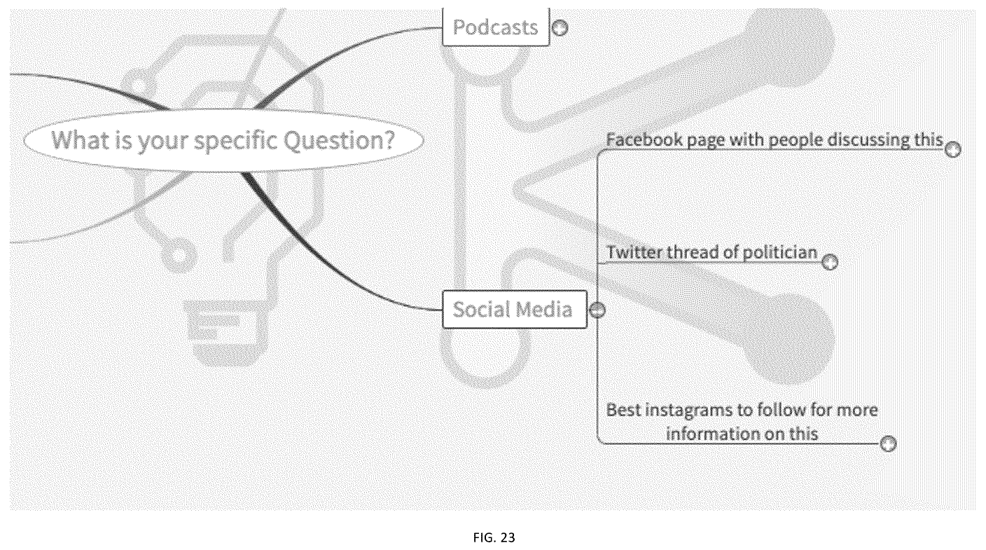

FIG. 23 is a screen display of another example of a focused section within FIG. 20.

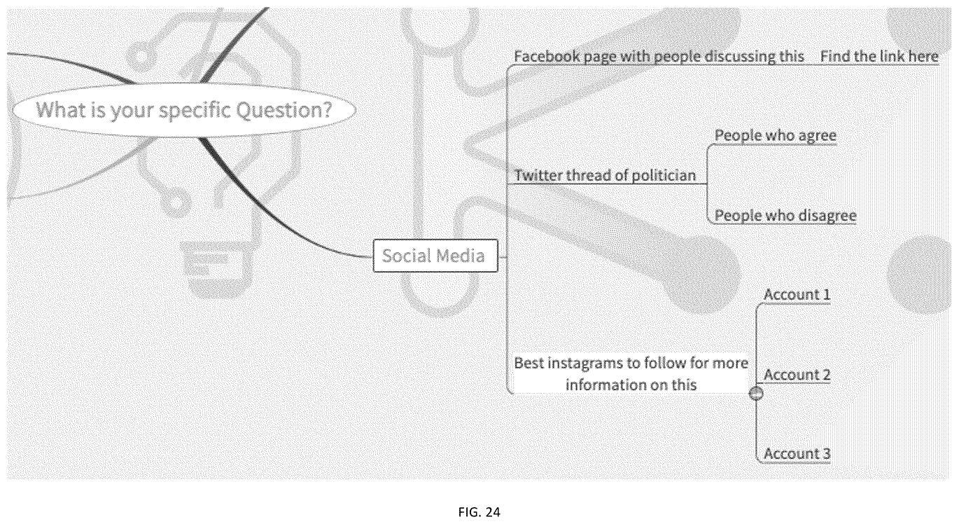

FIG. 24 is a screen display of another example of a larger focused section within FIG. 20 as it expands from FIG. 22.

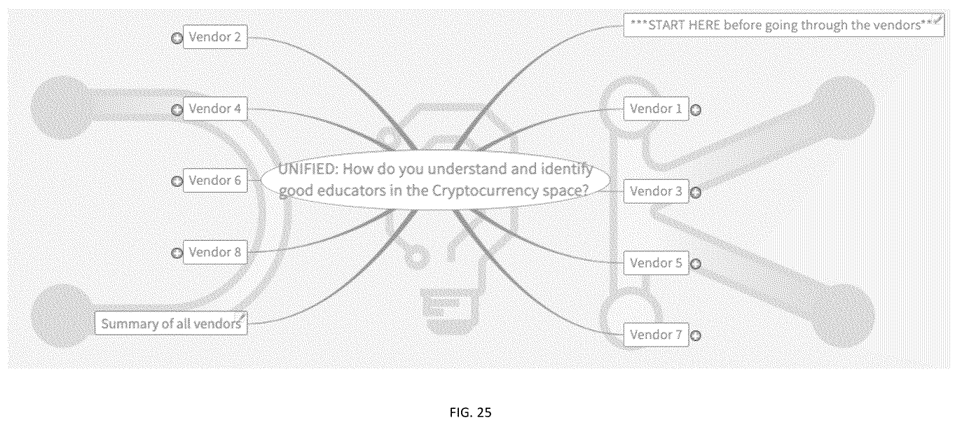

FIG. 25 is a screen display of another example of a unified electronic resource map.

Now turning again to FIG. 10, the user can use many variables to import identifiers into the unified electronic resource maps (step 1010). For example, the user may use the electronic device 122 of FIG. 1 to input the variables, which are communicated to server 102 for processing by the electronic resources manager 104. Variables include, but are not limited to, key terms, node ratings, electronic resource map ratings, number of times the electronic resource map was purchased, etc., to gauge, order, and import nodes, branches, and describers from retrieved electronic resource maps into unified electronic resource map. Further, at step 1012, the user can add unique nodes and describers within the unified electronic resource map. See the example of FIG. 25.

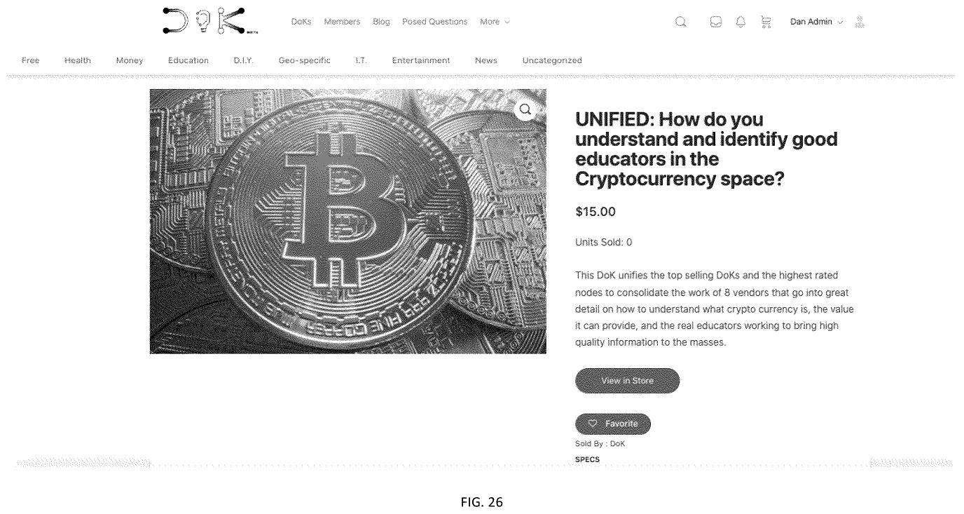

At step 1014, the user can make the unified electronic resource map available to the public. See the example of FIG. 26, which illustrates a screen display of an example of that unified electronic resource map being available to the public. FIG. 26 shows is a product page where a seeker can read the description of the DoK, see who the vendor is who created it, and potentially add it to their cart to purchase it. At step 1016, the user can continue this process any suitable number of times, continuously updating the unified electronic resource map as the number of retrieved electronic resource maps grow, related to the search terms. This includes unifying unified electronic resource maps.

In embodiments there are various sequences where a seeker and a vendor can connect, and the seeker can receive an electronic resource map that addresses their specific question. In one example, a vendor creates a custom electronic resource map for a seeker. Note, custom electronic resource map is needed if a seeker cannot find an already created DoK that they feel will properly address their question. It begins when a seeker first forms their question of interest. Subsequently, they search the website for a vendor that they believe can create the desired electronic resource map . An appropriate vendor can be evaluated by, or sufficient premade electronic resource maps, examining vendor profiles, ratings, comments, direct message, etc. (It is through the description of a premade electronic resource map that the vendor writes, and/or the profile., i.e. biography, interests, certifications, education, experience, of the vendor themselves, that the seeker selects who they think are the right person to create the electronic resource map that will best provide them with the qualified consolidated information they are looking for). Once one or several appropriate vendors are found, the seeker can reach out to them via direct message and ask further questions if needed. When the seeker believes they found the right vendor, or several capable vendors, the seeker will reach out to them by direct message and pose their question of interest. If the vendor believes they can create an electronic resource map that the seeker will be satisfied with, the vendor can offer it freely, or they can negotiate and agree on a price. Once agreed, the vendor creates the electronic resource map and uploads it to their store. Once the electronic resource map is available in the vendor's store, the seeker can buy it. Once purchased, the electronic resource map will be available in the seekers profile. From there, the seeker can open and will have full access to the electronic resource map .

In another example, the seeker finds a pre-made DoK. This sequence can begin by a seeker forming their question. Once the question is formed, the seeker can search through the already created DoKs that exist on the website. It is through the description of a pre-made electronic resource map that the vendor writes, and/or the profile of the vendor, i.e., biography, interests, certifications, education, experience, of the vendor themselves, that informs the seeker to select who they think are the right person to buy the premade electronic resource map from. Once the right electronic resource map is found, the seeker purchases it for the price on the DoK. Once bought, the seeker can have full access to the contents of the electronic resource map .

In another example, the seeker publishes a question of interest in the public forum. It begins by the seeker forming their question. Once formed, the seeker can publish their question in the appropriate category, along with the general price they would be willing to pay for an electronic resource map to address it. Vendors can explore the forum and find questions they believe they can address. Once a vendor finds a question, they believe they can address, they can direct message the seeker who posed it. The vendor tries to convince the seeker that they are the right person to address their question. Once the seeker agrees, the vendor can create the electronic resource map. When the electronic resource map is published and uploaded to their store, the seeker can now buy the electronic resource map for the agreed upon price. Once the electronic resource map is purchased, the seeker can full access to the contents of the electronic resource map.

In accordance with embodiments, a method is provided that can be performed on the internet via an e-commerce marketplace for creating an environment where digital products generally including an interconnected web of informational resources. The method can support the answering of a question of interest. Initially, a seeker develops a question of interest. Further, the seeker searches for a vendor that can create an interconnected web of informational resources (or electronic resource map) that support the answering of the seeker's question of the interest. The seeker contacts the vendor via direct messaging through the web site and enquires to see if the vendor will create an interconnected web of informational resources (or electronic resource map) that support the answering of a question of interest, as well as the time and interest. When the vendor agrees, the price is negotiated and agreed upon the vendor creates an interconnected web of informational resources (or electronic resource map) that support the answering of a question of interest. The vendor can make personal notes (describers) on each identifier resource (node) and/or topic that is within the electronic resource map. Once complete, the seeker purchases the interconnected web of informational resources (or electronic resource map) that support the answering of a question of interest and has instant access to it on their profile. The seeker can now view all the contents of the interconnected web of informational resources (or electronic resource map) that support the answering of a question of interest and interact with them via hyperlinks, opening notes, and navigating around. Also, the Vendor can create pre-made interconnected webs of informational resources (or electronic resource map). The vendor sets the price for these pre-made interconnected webs of informational resources (or electronic resource map). A seeker can search and instantly purchase a premade interconnected web of informational resources (or electronic resource map). The seeker can now view all the contents of the interconnected web of informational resources (or electronic resource map) that support the answering of a question of interest and interact with them via hyperlinks, opening notes, and navigating around. The seeker can post their question of interest on a public page that can be accessed by vendors. Vendors can search through questions that they believe they are able to create a suitable and valuable interconnected web of informational resources (or electronic resource map) for the seeker. The vendor can reach out to the seeker and pitch to them why they are the right person for the job of creating an interconnected web of informational resources (or electronic resource map) that can suitably support the seeker. When the vendor and seeker negotiate on the price and once a price is agreed upon by both parties, the vendor creates informational resources (or electronic resource map) around the question being asked by the buyer. Once complete, the seeker purchases the interconnected web of informational resources (or electronic resource map) that support the answering of a question of interest and has instant access to it on their profile. The seeker can now view all the contents of the interconnected web of informational resources (Mind map=electronic resource map) that support the answering of a question of interest and interact with them via hyperlinks, opening describers, and navigating around.

In embodiment, a method is provided by which a consolidated unified DoK is created from two or more electronic resource maps that relate to the same or a similar question. It may be that there is multiple vendors with electronic resource maps that aim to answer the same or similar questions, therefore creating an overlap in informational resources, and the capacity to bring in multiple perspectives around these questions. With multiple electronic resource maps created by multiple vendors relating to address the same or similar questions, claim two consists of the process to consolidate these multiple interconnected webs of informational resources (Mind map=electronic resource map) into a unified electronic resource map.

An electronic resource map as referred to herein, is a process where a vendor answers a specific question for the buyer using the structure of a mind-map where each ‘node’ in the mind-map is a resource (hyperlink to take the buyer to another location on the internet such as a blog, YouTube video, podcast, scientific paper, or a purchase page for a book, documentary, tool, etc.) or concept. The vendor also has the capacity to write about, or note, their opinion on each node via a describer, to allow for a deeper understanding of why it is included in the DoK and how it relates to answering the buyer's question.

In accordance with embodiments, a user can interact with systems as described herein via a website. For example, a suitable computing device with internet access can be used to access one or more web servers with systems and methods described herein implemented thereon. On an accessed website, the user can create a profile where they will have access to create a DoK via a suitable web interface. For example, the website can present one or more webpages that can present information and receive user input. In an example, a webpage can display a representation of graphics as described herein. The user can use a user interface (e.g., the mouse, trackpad, touch screen, and/or keyboard) of the computing device to construct a DoK. Further, the website can provide the user with formatting tools as well which are structured as menus and options. Initially, the user can puta question or topic of interest in a first and only node displayed by the user interface (e.g., a display screen). The user can subsequently create any needed number of connecting nodes where the user can provide input inside the node, insert an icon in a node, images, or URL links. The user can subsequently use the user interface to comment on any node they can create (such as in a pop-up window) that can then be linked to that specific node.

The user can use the user interface to navigate the window in multiple directions through keyboard shortcuts or by clicking and dragging in any direction. The user can use the user interface zoom in and zoom out. The user has the same capacity via touchscreens using the predefined finger motions.

In accordance with embodiments, two or more mind maps (or DoKs) can be linked. These may be mind maps created or generated by different users. In an example, a mind map may be linked manually by user input. In another example, nodes of different mind maps can be manually or automatically connected at nodes having the same or similar question, keyword, or phrase. For example, the system can link nodes having matching words, matching similar words, matching synonyms, or the like. Further, for example, words can be matched of different languages.

In accordance with embodiments, mind maps as disclosed herein can be searched by use of a suitable search function. For example, a user can use key search term(s) or phrases for searching entries in mind maps. The results of the search for matches or similar terms/phrases can be presented to the user and be selectable. The user can subsequently select one or more of the search results to review one or more associated mind maps. As an example, a user can use a user interface to search on the front end using a global search function. The user can begin to collect similar mind maps via the front end searching through the products as the product's title is the main questions/topic in a main node.

Further, mind maps can be searched on the back end within the products section. A user can download the results into a suitable viewable format, such as MICROSOFT EXCEL®. Since a title of the mind maps, and therefore the product, is the question/topic of interest, the main topic node can be compared in this manner. Once the user has a list of mind maps that seem similar via this main node search, the user can open each mind map and examine further by use of the user interface. As an example, examining further can mean looking through and comparing all the sub nodes, URLs, and vendors' comments and seeing how they relate to the other mind maps' sub nodes identified as similar.

In accordance with embodiments, nodes can be linked based on the author or creator of the content associated with the nodes. For example, videos posted online (e.g., a video posted on the YOUTUBE® website) by a particular creator in nodes of different mind maps can be linked based on them each having the same creator. In this example, this information can be associated with each node and use to link the nodes. Another important comparison is looking at the similar sources of information that is seen through multiple mind maps. In another example, publications, such as articles, in nodes of different mind maps can be linked together. The user can copy the sub nodes, their comments, and branches to the linked mind maps. This process can be done manually by the user, or automatically by the system.

In accordance with embodiments, systems disclosed herein can link nodes of different mind maps as described herein by manual linking. For example, a system can identify mind maps to combine via a keyword search of the main node (where the question/topic is being addressed). In this example, subsequent to identifying mind maps that are addressing the same question/topic of interest, the system can import all branches and their associated vendor comments into a unified mind map. The present subject matter may be a system, a method, and/or a computer program product. The computer program product may include a computer readable storage medium (or media) having computer readable program instructions thereon for causing a processor to carry out aspects of the present subject matter.

In accordance with embodiments, nodes of a mind map (or electronic resource map) can be associated with a rating value. A rating value can be an indicator of a ranking of nodes (or identifiers for electronic resources) among one another. One or more rating values of node(s) may be presented to a user so that the user may decide which node to select for viewing. A higher rating value of a node may indicate that it is a better source of information as compared to another node having a lower rating value. Rating values of nodes may be presented in any suitable manner, such as a listing, graphically, or the like.

A rating value may be determined based on users' input about the node. For example, a user presented with the node may input a score for the node. The input score and other input scores may be entered into a formula to calculate a rating value for the node. High scores can result in a high rating value, whereas low scores can result in a low rating value. The rating value of a node can change over time depending on scores input for the node.

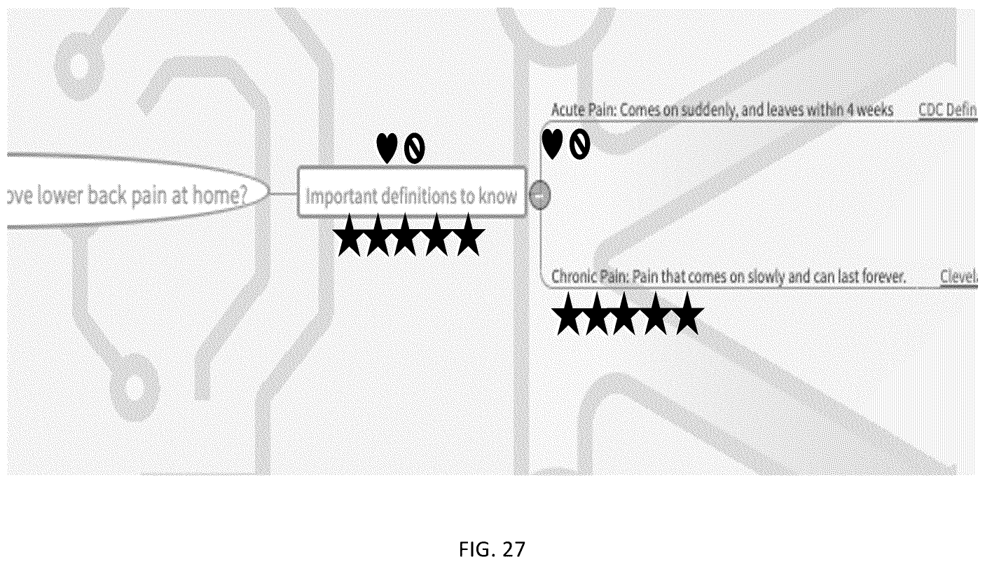

In accordance with embodiments, each node of an electronic resource map can represent some type of informational resource. Each node can represent some relationship to the subject or question of interest. Further, a user can rate categorically (e.g., Yes/No, Like/Dislike, has value/does not have value, etc.) or a scale (0-3, 0-5, etc.) of that node via shapes, symbols, numbers, or the like. FIG. 27 illustrates a screen display with nodes having categorical ratings (top heart/no symbol) and scale ratings (bottom stars).

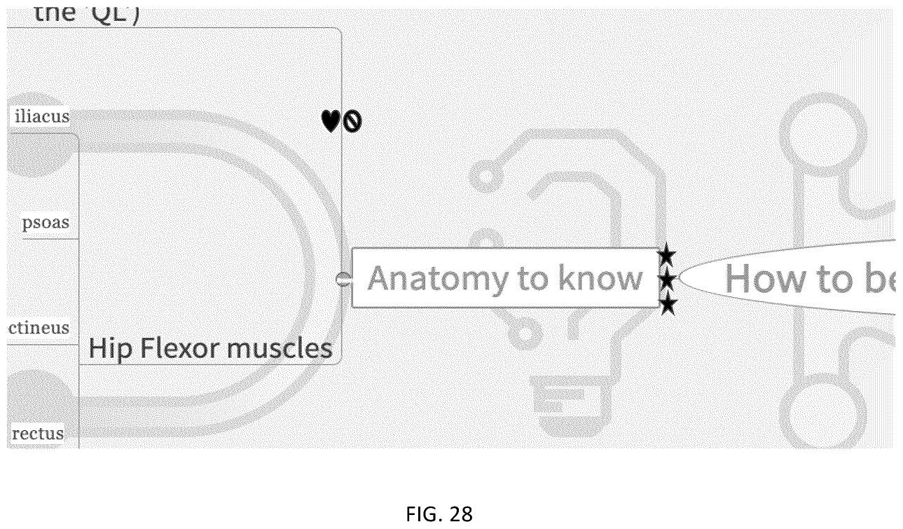

In accordance with embodiments, a branch can represent an arm stemming from a node. Each branch is a pathway the vendor uses to connect ideas and information resources. Therefore, the user can rate categorically (e.g., Yes/No, Like/Dislike, has value/does not have value, etc.) or a scale (0-3, 0-5, etc.) of each branch via shapes, symbols, numbers, or the like. FIG. 28 illustrates a screen display with branches having categorical ratings (top heart/no symbol) and scale ratings (bottom stars).

In accordance with embodiments, a creator of an electronic resource map can share URLs within the nodes as the URL itself or hyperlinked within text to direct the user to the associated web page. If the URL is used within a mindmap, it can be inferred that the info from the URL used will correspond to with question or topic of interest. The more a URL is used in creator's electronic resource maps, the more reinforced it will be that the URL is valuable within context of the associated question/topic of interest. By collecting the core or root of the URL, i.e. ‘www.example.com’/blog or ‘www.example.com’/info/goodexamples, all used URLs can be collected from that website and its corresponding pages. Over time, this can aid in an optimized search engine: When a user searches for a question or topic, we can rank order the results based on the number of times, and how it was ranked/valued (as explained earlier, in slide 2) within the mind maps that included them and the users that ranked them. This will be dynamic and constantly update as new mindmaps are created and nodes created. Also, the owner of the URLs that are used in the mindmaps can be given a ticker or symbol or some sort of visualization, that they can post on their website as a marker of legitiamacy/value.

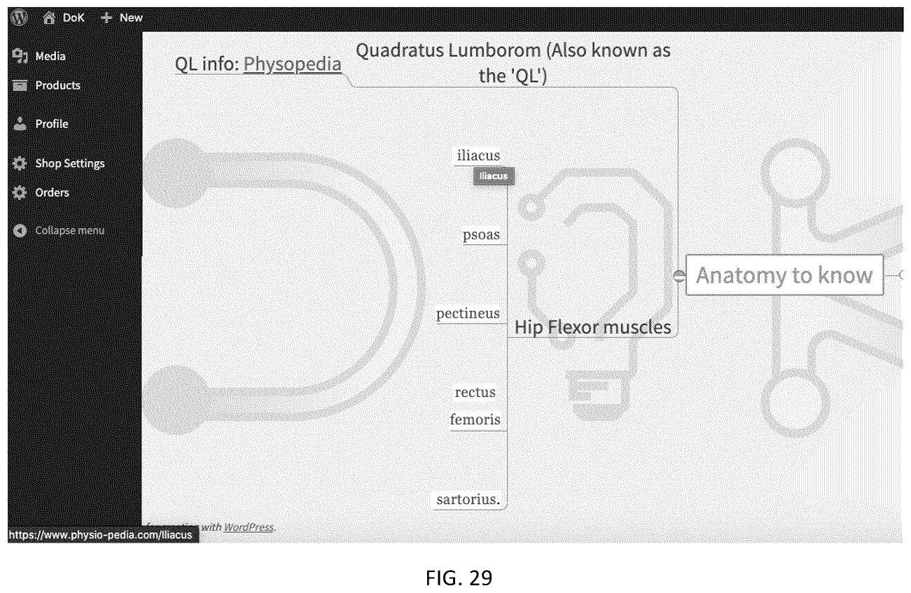

In embodiments, a URL may be embedded in text. FIG. 29 is a screen display in which “Iliacus” is hyperlinked. In an example, when a user hovers your mouse over the word, the user can see the hyperlink in the bottom left corner. In this example, www.physio-pedia.com is the main website. Therefore, this would be counted as +1 for www.physio-pedia.com. Each URL that is used can be counted and stored.

As referred to herein, a computer network may be any group of computing systems, devices, or equipment that are linked together. Examples include, but are not limited to, local area networks (LANs) and wide area networks (WANs). A network may be categorized based on its design model, topology, or architecture. In an example, a network may be characterized as having a hierarchical internetworking model, which divides the network into three layers: access layer, distribution layer, and core layer. The access layer focuses on connecting client nodes, such as workstations to the network. The distribution layer manages routing, filtering, and quality-of-server (QoS) policies. The core layer can provide high-speed, highly-redundant forwarding services to move packets between distribution layer devices in different regions of the network. The core layer typically includes multiple routers and switches.

The device or system for performing one or more operations on a memory of a computing device may be a software, hardware, firmware, or combination of these. The device or the system is further intended to include or otherwise cover all software or computer programs capable of performing the various heretofore-disclosed determinations, calculations, or the like for the disclosed purposes. For example, exemplary embodiments are intended to cover all software or computer programs capable of enabling processors to implement the disclosed processes. Exemplary embodiments are also intended to cover any and all currently known, related art or later developed non-transitory recording or storage mediums (such as a CD-ROM, DVD-ROM, hard drive, RAM, ROM, floppy disc, magnetic tape cassette, etc.) that record or store such software or computer programs. Exemplary embodiments are further intended to cover such software, computer programs, systems and/or processes provided through any other currently known, related art, or later developed medium (such as transitory mediums, carrier waves, etc.), usable for implementing the exemplary operations disclosed below.

In accordance with the exemplary embodiments, the disclosed computer programs can be executed in many exemplary ways, such as an application that is resident in the memory of a device or as a hosted application that is being executed on a server and communicating with the device application or browser via a number of standard protocols, such as TCP/IP, HTTP, XML, SOAP, REST, JSON and other sufficient protocols. The disclosed computer programs can be written in exemplary programming languages that execute from memory on the device or from a hosted server, such as BASIC, COBOL, C, C++, Java, Pascal, or scripting languages such as JavaScript, Python, Ruby, PHP, Perl, or other suitable programming languages.

The functional units described in this specification have been labeled as computing devices. A computing device may be implemented in programmable hardware devices such as processors, digital signal processors, central processing units, field programmable gate arrays, programmable array logic, programmable logic devices, cloud processing systems, or the like. The computing devices may also be implemented in software for execution by various types of processors. An identified device may include executable code and may, for instance, comprise one or more physical or logical blocks of computer instructions, which may, for instance, be organized as an object, procedure, function, or other construct. Nevertheless, the executable of an identified device need not be physically located together but may comprise disparate instructions stored in different locations which, when joined logically together, comprise the computing device and achieve the stated purpose of the computing device. In another example, a computing device may be a server or other computer located within a retail environment and communicatively connected to other computing devices (e.g., POS equipment or computers) for managing accounting, purchase transactions, and other processes within the retail environment. In another example, a computing device may be a mobile computing device such as, for example, but not limited to, a smart phone, a cell phone, a pager, a personal digital assistant (PDA), a mobile computer with a smart phone client, or the like. In another example, a computing device may be any type of wearable computer, such as a computer with a head-mounted display (HMD), or a smart watch or some other wearable smart device. Some of the computer sensing may be part of the fabric of the clothes the user is wearing. A computing device can also include any type of conventional computer, for example, a laptop computer or a tablet computer. A typical mobile computing device is a wireless data access-enabled device (e.g., an iPHONE® smart phone, a BLACKBERRY® smart phone, a NEXUS ONE™ smart phone, an iPAD® device, smart watch, or the like) that is capable of sending and receiving data in a wireless manner using protocols like the Internet Protocol, or IP, and the wireless application protocol, or WAP. This allows users to access information via wireless devices, such as smart watches, smart phones, mobile phones, pagers, two-way radios, communicators, and the like. Wireless data access is supported by many wireless networks, including, but not limited to, Bluetooth, Near Field Communication, CDPD, CDMA, GSM, PDC, PHS, TDMA, FLEX, ReFLEX, iDEN, TETRA, DECT, DataTAC, Mobitex, EDGE and other 2G, 3G, 4G, 5G, and LTE technologies, and it operates with many handheld device operating systems, such as PalmOS, EPOC, Windows CE, FLEXOS, OS/9, JavaOS, iOS and Android. Typically, these devices use graphical displays and can access the Internet (or other communications network) on so-called mini- or micro-browsers, which are web browsers with small file sizes that can accommodate the reduced memory constraints of wireless networks. In a representative embodiment, the mobile device is a cellular telephone or smart phone or smart watch that operates over GPRS (General Packet Radio Services), which is a data technology for GSM networks or operates over Near Field Communication e.g. Bluetooth. In addition to a conventional voice communication, a given mobile device can communicate with another such device via many different types of message transfer techniques, including Bluetooth, Near Field Communication, SMS (short message service), enhanced SMS (EMS), multi-media message (MMS), email WAP, paging, or other known or later-developed wireless data formats. Although many of the examples provided herein are implemented on smart phones, the examples may similarly be implemented on any suitable computing device, such as a computer.

An executable code of a computing device may be a single instruction, or many instructions, and may even be distributed over several different code segments, among different applications, and across several memory devices. Similarly, operational data may be identified and illustrated herein within the computing device, and may be embodied in any suitable form and organized within any suitable type of data structure. The operational data may be collected as a single data set, or may be distributed over different locations including over different storage devices, and may exist, at least partially, as electronic signals on a system or network.

The described features, structures, or characteristics may be combined in any suitable manner in one or more embodiments. In the following description, numerous specific details are provided, to provide a thorough understanding of embodiments of the disclosed subject matter. One skilled in the relevant art will recognize, however, that the disclosed subject matter can be practiced without one or more of the specific details, or with other methods, components, materials, etc. In other instances, well-known structures, materials, or operations are not shown or described in detail to avoid obscuring aspects of the disclosed subject matter.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a RAM, a ROM, an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network, or Near Field Communication. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present subject matter may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++, Javascript or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present subject matter.

Aspects of the present subject matter are described herein with reference to flowchart illustrations and/or block diagrams of methods, apparatus (systems), and computer program products according to embodiments of the subject matter. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present subject matter. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the embodiments have been described in connection with the various embodiments of the various figures, it is to be understood that other similar embodiments may be used, or modifications and additions may be made to the described embodiment for performing the same function without deviating therefrom. Therefore, the disclosed embodiments should not be limited to any single embodiment, but rather should be construed in breadth and scope in accordance with the appended claims.

What is claimed is:

1. A method of generating an electronic resources map, the method comprising:
determining a subject of interest;
receiving user input that identifies a plurality of electronic resources associated with the subject of interest;
receiving user input that identifies an association of the electronic resources to each other and the subject of interest;
creating an electronic resources map comprising a first data structure including first identifiers for the electronic resources and first links among the electronic resources based on the user input;
providing a subject of interest of a second data structure comprising second identifiers for a plurality of second electronic resources and second links among the second electronic resources;
determining that the subject of interest of the first data structure relates to the subject of interest of the second electronic resources; and
linking at least one of the first electronic resources to at least one of the second electronic resources based on the determination that the subject of interest of the first data structure relates to the subject of interest of the second electronic resources.

2. The method of claim 1, wherein the subject of interest is associated with a query.

3. The method of claim 1, wherein the electronic resources are each identified by a web address and/or a hyperlink.

4. The method of claim 1, further comprising providing a user interface configured to:
present the first electronic resources map and the second electronic resources map to a user; and
receive user input for interaction with the first electronic resources map and the second electronic resources map.

5. The method of claim 1, further comprising receiving user input for notating one or more of the electronic resources in the data structure.

6. The method of claim 1, further comprising:
receiving, via user input, a score for one or more electronic resources or identifiers;
determining a rating value for each of the scored one or more electronic resources based on the score; and
presenting the rating value to a user.

7. The method of claim 1, wherein two or more of the first or second electronic resources are associated by a branch in the first or second data structure, and wherein the method further comprises:
receiving, via user input, a rating value for the branch; and
presenting the rating value to a user.

8. The method of claim 1, providing a user interface configured to display a visual representation of the electronic resources map, the first and second electronic resources, and links among the first and second electronic resources.

9. A method of using an electronic resources map, the method comprising
providing an electronic resources map associated with a subject of interest, wherein the electronic resources map comprises a data structure including identifiers for electronic resources and links among the electronic resources based on user input;
presenting, via a user interface, the electronic resources map to a user; and
receiving, via the user interface, user input for interaction with the electronic resources map.

10. The method of claim 9, wherein the data structure is a first data structure, the identifiers are first identifiers, the electronic resources are first electronic resources, and the links are first links,
wherein the electronic resources map comprises a second data structure comprising second identifiers for a plurality of second electronic resources and second links among the second electronic resources, and
wherein the method further comprises:
determining that the subject of interest of the first data structure relates to a subject of interest of the second electronic resources; and
linking at least one of the first electronic resources to at least one of the second electronic resources based on the determination that the subject of interest of the first data structure relates to the subject of interest of the second electronic resources.

11. The method of claim 9, wherein the subject of interest is associated with a query.

12. The method of claim 9, wherein the electronic resources are each identified by a web address and/or a hyperlink.

13. The method of claim 9, further comprising providing a user interface configured to:
present the electronic resources map to a user; and
receive user input for interaction with the electronic resources map.

14. The method of claim 9, further comprising receiving user input for notating one or more of the electronic resources in the data structure.

15. The method of claim 9, further comprising:
receiving, via user input, a score for one or more electronic resources or identifiers;
determining a rating value for each of the scored one or more electronic resources based on the score; and
presenting the rating value to a user.

16. A system comprising:
at least one computing device configured to:
determine a subject of interest;
receive user input that identifies a plurality of electronic resources associated with the subject of interest;
receive user input that identifies an association of the electronic resources to each other and the subject of interest;
create an electronic resources map comprising a first data structure including first identifiers for the electronic resources and first links among the electronic resources based on the user input;
provide a subject of interest of a second data structure comprising second identifiers for a plurality of second electronic resources and second links among the second electronic resources;
determine that the subject of interest of the first data structure relates to the subject of interest of the second electronic resources; and
link at least one of the first electronic resources to at least one of the second electronic resources based on the determination that the subject of interest of the first data structure relates to the subject of interest of the second electronic resources.

17. A computer program product comprising a computer readable storage medium having program instructions embodied therewith, the program instructions executable by a computing device to cause the computing device to:
determine, at the computing device, a subject of interest;
receive, at the computing device, user input that identifies a plurality of electronic resources associated with the subject of interest;
receive, at the computing device, user input that identifies an association of the electronic resources to each other and the subject of interest;
create, at the computing device, an electronic resources map comprising a first data structure including first identifiers for the electronic resources and first links among the electronic resources based on the user input;
provide, at the computing device, a subject of interest of a second data structure comprising second identifiers for a plurality of second electronic resources and second links among the second electronic resources;
determine, at the computing device, that the subject of interest of the first data structure relates to the subject of interest of the second electronic resources; and
link, at the computing device, at least one of the first electronic resources to at least one of the second electronic resources based on the determination that the subject of interest of the first data structure relates to the subject of interest of the second electronic resources.
